(19) United States
(12) Patent Application Publication
(10) Pub. No.: US 2020/0373874 A1
(43) Pub. Date: Nov. 26, 2020

(54) System for Converting Solar Energy into Electricity

(71) Applicants: Jose E. Gutierrez, San Juan, PR (US); Yazied E. Perez, San Juan, PR (US); Karina M. Ramos, San Juan, PR (US); Pedro A. Gonzalez, San Juan, PR (US)

(72) Inventors: Jose E. Gutierrez, San Juan, PR (US); Yazied E. Perez, San Juan, PR (US); Karina M. Ramos, San Juan, PR (US); Pedro A. Gonzalez, San Juan, PR (US)

(21) Appl. No.: 16/879,483

(22) Filed: May 20, 2020

Related U.S. Application Data
(60) Provisional application No. 62/850,466, filed on May 20, 2019.

(51) Int. Cl. H02S 10/40; H02S 40/36; H02S 40/32; H02S 40/38

(52) U.S. Cl. CPC H02S 10/40; H02S 40/38; H02S 40/32; H02S 40/36

(57) ABSTRACT

A system for converting solar energy into electricity that comprises a solar box, solar panels, cables and connectors, a charge controller, an inverter, and one or more batteries.

### BACKGROUND

People who rely on the use of electricity or electrical power to run their households or businesses face many challenges. Many of these systems are unreliable, unstable or costly to run. Moreover, there are limited alternative non-emission energy solutions in the market that are also affordable.

The purpose of the disclosure is to empower people struggling with electric system failure caused by hurricanes or the like or to help those dealing with an aging-inefficient electric grid.

For example, the disclosure would be able to help unreliable, unstable, fragile and costly electrical system in Puerto Rico for 1.0 million residential customers. It would also help provide limited viable non-emissions energy alternative solutions for households or small businesses.

### SUMMARY

The disclosure relates to an affordable, compact, decorative, emission and maintenance free, solar generator that provides electricity depending on the user's needs.

### BRIEF DESCRIPTION OF THE DRAWINGS

FIG. 1 shows a system for converting solar energy into electricity.

FIG. 2 shows a method of converting solar energy into electricity.

FIG. 3 shows a decorative container for storing certain components of the system for converting solar energy into electricity.

### DETAILED DESCRIPTION

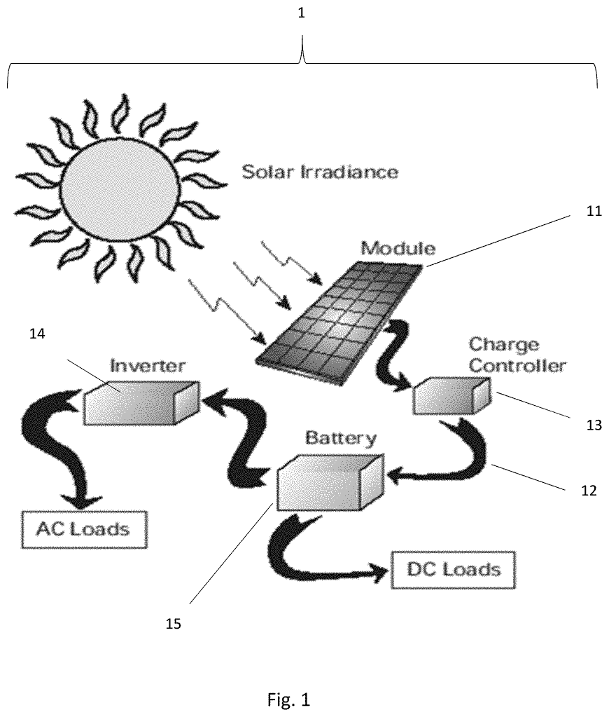

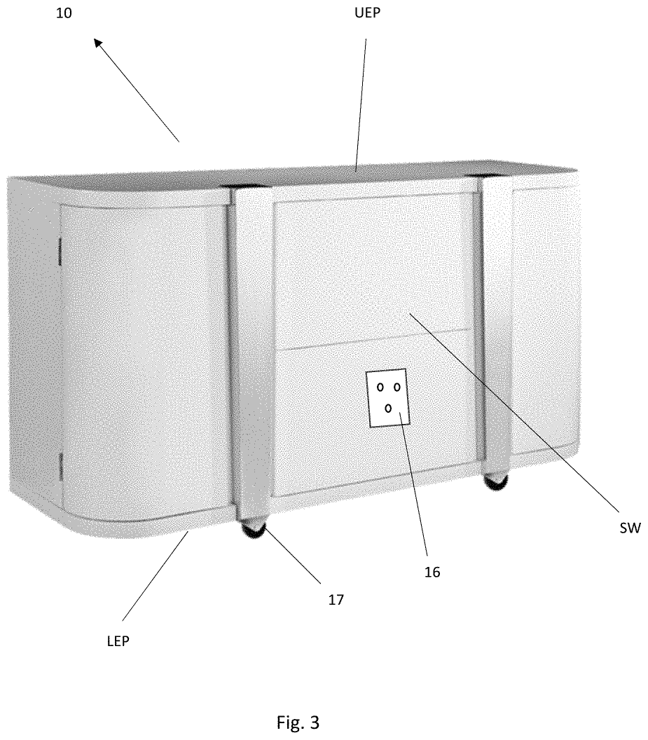

As shown in FIG. 1 and FIG. 3, the system for converting solar energy into electricity 1 comprises a solar box 10, one or more solar panels 11, one or more cables and connectors 12, at least one charge controller 13, at least one inverter 14, and one or more batteries 15. In a preferred embodiment, the voltage of the one or more batteries 15 should be 12V or higher.

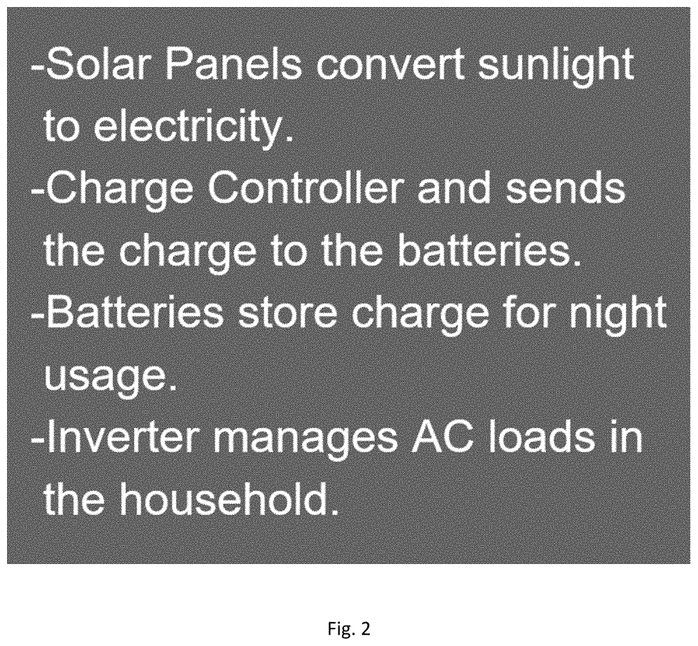

As shown in FIG. 2, the disclosed invention works as follows: 1) solar panels 11 convert sunlight to electricity; 2) the charge controller 13 sends charge to the one or more batteries 15; 3) the one or more batteries 15 store charge for night usage; and 4) an inverter 14 manages AC loads in the household.

The solar box 10, as shown in FIG. 3, is a decorative container that holds inside the cables and connectors 12, the charge controller 13, the inverter 14, and the one or more batteries 15. The solar box 10 has sidewalls SW, an upper end portion UEP and a lower end portion LEP. The solar box 10 may include one or more electric plugs 16 on one of the side walls SW. The electric plugs are connected to the one or more batteries 15 inside of the solar box 10, via the cables and connectors 12. A user of the system for converting solar energy into electricity 1 can then connect one end of an extension cable to the electric plug 16 and the other end of the cable to an electric plug of a house in order to energize the house. In a preferred embodiment, the solar box 10 also has wheels 17 for easy transportation of the solar box 10.

Although certain exemplary embodiments and methods have been described in some detail, for clarity of understanding and by way of example, it will be apparent from the foregoing disclosure to those skilled in the art that variations, modifications, changes, and adaptations of such embodiments and methods may be made without departing from the true spirit and scope of the claims. Therefore, the above description should not be taken as limiting the scope of the invention which is defined by the appended claims

The invention is not limited to the precise configuration described above. While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means plus function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patently distinguish any amended claims from any applied prior art.

What is claimed is:

1. A system for converting solar energy into electricity, comprising:
a solar box, one or more solar panels, one or more cables and connectors, at least one charge controller, at least one an inverter, and one or more batteries;
wherein the solar one or more solar panels are connected via the or more cables and connectors to the at least one charge controller;
wherein the at least one charge controller is connected via the or more cables and connectors to the one or more batteries;
wherein the one or more batteries are connected via the or more cables and connectors to the at least one an inverter;
wherein the solar box has sidewalls, an upper end portion and a lower end portion; and
wherein the one or more solar panels, the one or more cables and connectors, the at least one charge controller, the at least one an inverter, and the one or more batteries are sored inside the solar box.

2. The system for converting solar energy into electricity of claim 1, wherein:
the solar panels converts sunlight to electric charge;
the charge controller sends the electric charge to the one or more batteries;
the one or more batteries store the electric charge for usage; and
the inverter manages AC loads in a household.

3. The system for converting solar energy into electricity of claim 1, wherein the one or more batteries have a voltage of 12V or higher.

4. The system for converting solar energy into electricity of claim 1, wherein the solar box includes one or more electric plugs on one of the side walls.

5. The system for converting solar energy into electricity of claim 1, wherein the solar box includes one or more wheels for easy transportation of the solar box.
